(19) United States
(12) Patent Application Publication
(10) Pub. No.: US 2008/0318544 A1
(43) Pub. Date: Dec. 25, 2008

(54) Frequency mixer

(75) Inventors: Rachel Dan Wang, Hong Kong (CN); Francis Yeun Cheul Jeung, Hong Kong (CN)

Correspondence Address: WELLS ST. JOHN P.S., 601 W. FIRST AVENUE, SUITE 1300, SPOKANE, WA, 99201, US

(73) Assignee: Hong Kong Applied Science and Technology Research Institute Company Limited

(21) Appl. No.: 11/820,698

(22) Filed: Jun. 20, 2007

(51) Int. Cl. H04B 1/26

(52) U.S. Cl. 455/323

(57) ABSTRACT

A mixer for mixing first and second input signals having first and second frequencies respectively. A voltage-to-current converter is coupled with an input for converting a first input signal into a current signal. A multiplier circuit is coupled with the voltage-to-current converter for multiplying the current signal with a second input signal to form an output signal at an output. A matching circuit is provided that couples a component of the current signal back to the input. The matching circuit can comprise a feedback resistor for feeding a part of the current signal back to the input. The second input signal is received at a second input coupled to a second voltage-to-current converter for converting a second input signal into a second current signal. In one embodiment of the mixer the second input is a local oscillator and the current signal is multiplied with a local oscillator signal to form an output signal at the output.

### BACKGROUND TO THE INVENTION

1. Field of the Invention

The current invention relates to frequency mixers generally, and to mixers for mixing a radio frequency signal with and local oscillator signal to produce an intermediate frequency signal.

2. Background Information

Frequency mixers are used for frequency conversion and are an essential component in modern radio frequency (RF) systems. A typical RF application of a mixer is to convert a radio frequency (RF) signal into a lower intermediate frequency (IF) signal. This frequency reduction allows for simpler signal processing and/or high gain amplification of the signal without the risk of instability or oscillations that might occur in high gain amplification of radio frequencies.

A number of problems exist with known RF mixers. One problem is the common use of on-chip spiral inductors in order to achieve wideband matching of the mixer. These spiral inductors require a large die area and result in high production costs. An alternative to using spiral inductors is to use a series of narrow band mixers in parallel in order to achieve a specific bandwidth and wideband matching. However, this solution also uses a large die area and results in high production costs. A further disadvantage of known mixers is that some require accurate pre-distortion to cancel any non-linearities and to achieve a required performance and wideband matching. Accurate pre-distortion becomes difficult to achieve due to process variations and low production quality and thus this sort of mixer becomes more expensive to make.

Accordingly, there exists a need for an improved frequency mixer that can be used in RF applications.

### SUMMARY OF THE INVENTION

There is disclosed herein a mixer for mixing first and second input signals having first and second frequencies respectively. In the mixer a voltage-to-current converter is coupled with an input for converting a first input signal into a current signal. A multiplier circuit is coupled with the voltage-to-current converter for multiplying the current signal with a second input signal to form an output signal at an output. And, a matching circuit is provided that couples a component of the current signal back to the input. The matching circuit can comprise a feedback resistor for feeding a part of the current signal back to the input. The second input signal is received at a second input coupled to a second voltage-to-current converter for converting a second input signal into a second signal.

In one embodiment of the mixer the second input is a local oscillator and the current signal is multiplied with a local oscillator signal to form an output signal at the output.

Preferably, the voltage-to-current converter comprises a first voltage drive transistor and the multiplier circuit comprises a second voltage transistor in series with the first voltage drive transistor for converting the oscillator signal to an oscillator current signal and mixing it with the input current signal.

In another embodiment the mixer further comprises a complimentary pair of each of said voltage-to-current converter, multiplier circuit and matching circuit. The input signal and a local oscillator signal comprise differential signals having positive and negative components for mixing by said complimentary pairs.

Preferably, the multiplier circuit comprises a pair of parallel transistors driven by the local oscillator signal for steering the current signal through one or both of the transistors in synchronization with the local oscillator signal.

Preferably, the mixer further comprises a current-to-voltage converter for coveting the output signal to an output voltage.

Preferably, the mixer further comprises the current-to-voltage converter is a resister coupled with the mixer.

Further aspects and disclosure of the invention will become apparent from the following description which is given by way of example only.

### BRIEF DESCRIPTION OF THE DRAWINGS

FIG. 1 is a schematic illustration of a single-end signal mixer according to the invention,

FIG. 2 illustrates the gain characteristics of a mixer according to the invention,

FIG. 3 is a schematic illustration of a second embodiment of a single-end signal mixer according to the invention, and

FIG. 4 is a schematic illustration of a signal mixer for differential input signals.

### DETAILED DESCRIPTION OF THE EXEMPLARY EMBODIMENTS

An exemplary embodiment of the current invention will now be described as practice in a wideband mixer for converting a radio frequency (RF) signal to an intermediate frequency (IF) signal by mixing the RF signal with a local oscillator (LO) signal. However, this is not intended to limit the scope of use or functionality of the invention. The skilled addressee will appreciate that a mixer of the current invention is a signal multiplier that has as its inputs two signals having first and second frequencies and as its output the sum and difference frequencies of the first and second frequencies. Such a mixer may find application in fields other than RF to IF conversion in RF systems.

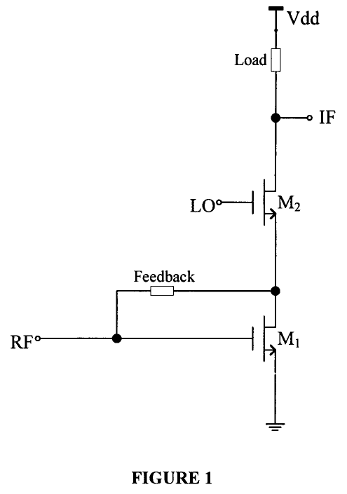

Referring to FIG. 1, which is the simplest exemplified embodiment of the invention, a mixer circuit comprises a load resistor and a pair of voltage driven metal-oxide-semiconductor field-effect transistors (MOSFETs) M1 and M2 connected in series. The two MOSFETs are connected in series with the drain of MOSFET M2 connected with the source of MOSFET M1. The load resistor is connected between a voltage source Vdd and the source of MOSFET M2 and the drain of MOSFET M1 is connected to ground to complete the circuit.

Two inputs to the circuit are provided at the gates of MOSFETs M1 and M2 respectively. In the RF mixer application a LO signal is input at the gate of M1 and a RF signal is input at the gate of M2. It will be appreciated by the skilled addressee that in a RF system the local oscillator may be part of the mixer circuit. An integral local oscillator is not shown in the drawings to avoid undue complexity. The source to drain conductivity of each MOSFETs M1 and M2 varies in accordance with the voltage of the respective RF and LO signals at its gate, thus the MOSFETs convert the input RF and LO voltage signals into source-drain current signals in the MOSFETs. The series arrangement of the two MOSFETs M1 and M2 multiplies the respective current signals. The output, or intermediate frequency (IF), is obtained from the source of MOSFET M2. It will be appreciated by the skilled addressee that the IF signal comprises the sum and difference frequencies of the input RF and LO signals. For use in RF systems to obtain the intermediate frequency the output IF signal is passed through a low past filter (LPF), which is not shown, to remove the sum frequency leaving only the difference frequency.

The load resistor converts the current signals back to a voltage output voltage signal and avoids the need for inductors of the prior art devices which saves on die area and provides circuit stability while allowing the use of a low supply voltage Vdd.

A feedback resistor is provided from the source of MOSFET M2 to the gate of M2. The feedback resistor performs an impedance matching function and is used for wideband matching. The value of the feedback resistor is chosen to give an appropriate input resistance for M2 as required for impedance matching with the input RF signal. As the skilled addressee will appreciate, a resistor in this configuration acts a current-to-voltage converter, e.g. the voltage across the resistor is proportional to the current through the resistor, to feed a portion of the MOSFET channel current back to the MOSFET input.

The Miller equivalent input impedance of the RF input MOSFET M2 can be expressed as Rin=Rf/(1−Av), where Rf is the value of the feedback resistor and Av is the open-loop voltage gain of the mixer.

The quality factor, or Q-factor, of a device is an important characteristic in high frequency applications. The Q-factor of MOSFET M1 is given by:

$$Q = \frac{1}{[ R 1 + \frac{1}{Rin} ] \times ω \times Cgs}$$

where ω is the nominal operating frequency and Cgs is the gate-source capacitance of M1.

The relationship between bandwidth and the Q-factor for a MOSFET can be expressed as

Bandwidth=ω/Q

Substituting for Q and Rin it can be seen that the bandwidth of the mixer can be selected by adjustment of the feedback resistor Rf. It will be apparent to the skilled addressee that by replacing Rf with an analog or digital variable resistor network a mixer can be made with and adjustable and/or programmable bandwidth.

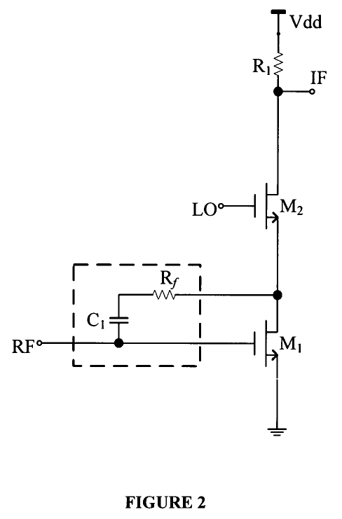

FIG. 2 shows the gain of a wideband mixer according to the invention. It can be seen that the mixer has a steady −2 dB gain through the frequency input range 3.1 to 4.8 GHz. In test circuit, the feedback resister's (Rf) value is approximately 300 Ohm and the transistors' are several hundred micro-meters (um). The circuit is using 0.18 um process and working at 1.8V supply voltage.

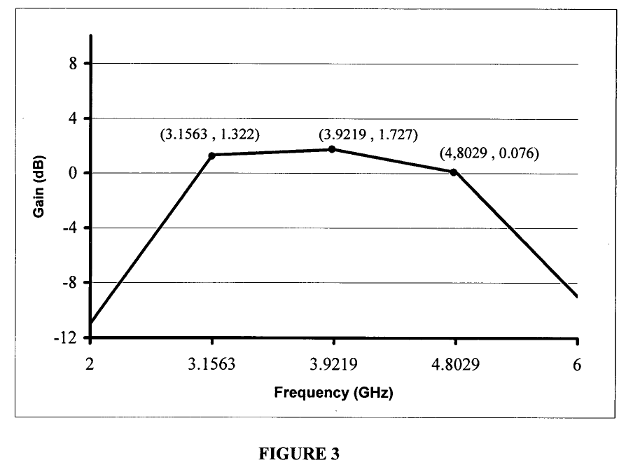

Referring to FIG. 3, a second exemplary embodiment of the circuit of FIG. 1 is shown. In this circuit an additional feedback capacitor C1 is provided in series with the feedback resistor Rf between the source and gate of MOSFET M2. The capacitor C1 prevents any DC component of the MOSFETs source current being fed back to its gate.

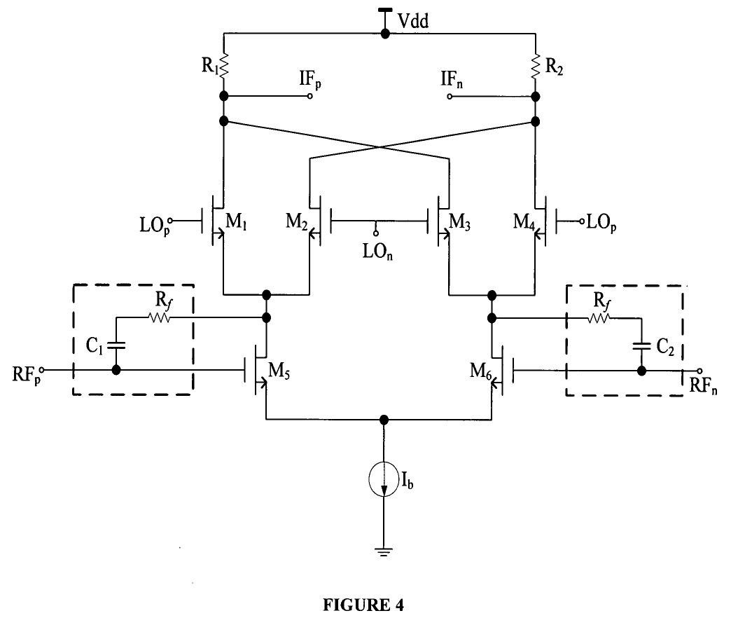

The above discussed exemplary embodiments of the invention are for single-end signals. However, the skilled addressee will appreciate that most modern systems use differential signalling in which a signals value is the difference between two individual positive and negative component signals. The positive and negative component signals are carried on separate conductors with the signal value being the difference between the individual voltages on each conductor. The skilled addressee will understand that for differential signalling a pair of terminals is required for each input signal and the output signal. FIG. 4 illustrates an exemplary embodiment of the current invention for use with differential signals. The embodiment of FIG. 4 comprises a complimentary pair of the circuit shown in FIG. 2 with the addition of additional current-steering MOSFETs to provide cross over between the individual input signals and a current source to set up a minimum drain current for the MOSFETs.

Referring to FIG. 4, the differential signal mixer comprise a pair of RF signal input MOSFETs M5 and M6 for converting individual positive and negative RF signals into respective current signals. The positive RF signal RFp is connected to the gate of MOSFET M5 and the negative RF signal RFn is connected to the gate of MOSFET M6. The local oscillator input comprises two pairs of complimentary MOSFETs M1, M2 and M3, M4 respectively. The MOSFETs M1-M4 convert the local oscillator voltage signals LOp and LOn into respective current signals and act as steering switches to modulate the component LO current signals with the component RF current signals. The first pair of MOSFETs M1, M2 have their drains connected together and with the source of RF input MOSFET M5. The positive local oscillator signal LOp is connected to the gate of MOSFET M1 and the negative local oscillator signal LOn is connected to the gate of M2. The other pair of oscillator MOSFETs M3, M4 have their drains connected to the source of negative RF signal MOSFET M6. The positive local oscillator signal Lop is connected to the gate of MOSFET M4 and the negative local oscillator signal LOn is connected with the gate of MOSFET M3. To provide current-steering between the positive and negative differential signals there is source crossover between the two pairs of local oscillator MOSFETs. MOSFET M2 has its source connected with the source of MOSFET M4 and MOSFET M3 has its source connected with the source of MOSFET M1. A pair of load resistors R1 and R2 is provided between a voltage source Vdd and the respective source terminals of MOSFETs M1, M3 and M4, M2 respectively. The differential positive and negative output intermediate frequency signals IFp and IFn are taken from the source terminals of respective MOSFETs M1, M3 and M4, M2. The drain terminals of RF input MOSFETs M5 and M6 are connected through a current source Ib to ground. The current source Ib maintains a minimum drain current in the MOSFETs.

As with the earlier exemplified embodiments a feedback resistor Rf, and optionally a capacitor C1/C2, is provided between the source and gate of each RF input MOSFETs M5 and M6 for wideband signal matching.

The wideband mixer according to the invention has a number of advantages over mixers of the art including that no spiral inductor is required which saves space and manufacturing costs. The invention uses an all CMOS technology with a single feedback resistor to provide simple wideband matching. The invention is also able to provide stable high gain control meaning that a single mixer can be used which results in less power consumption in the RF system. Because of the wideband mixing the mixer can connect directly to a low noise amplifier output of the RF circuit.

Exemplary forms of the invention have been described and are not intended to limit the scope of use or functionality of the invention. It should be appreciated that modifications and alternations obvious to those skilled in the art are not to be considered as beyond the scope of the present invention.

What is claimed is:

1. A mixer for mixing first and second input signals having first and second frequencies respectively, the mixer comprising:
an input and an output,
a voltage-to-current converter coupled with the input for converting a first input signal into a current signal,
a multiplier circuit coupled with the voltage-to-current converter for multiplying the current signal and a second input signal to form an output signal at the output, and
a matching circuit coupling a component of the current signal to the input.

2. The mixer of claim 1 further including a second input for receiving the second input signal, and a second voltage-to-current converter coupled with the second input for converting a second input signal into a second signal.

3. The mixer of claim 1 wherein the voltage-to-current converter comprises a voltage driven transistor having a base connected with the input.

4. The mixer of claim 1 wherein the matching circuit comprises a feedback resistor for feeding a part of the current signal back to the input.

5. The mixer of claim 1 further comprising a complimentary pair of each of said voltage-to-current converter, multiplier circuit and matching circuit, and wherein the first and second input signals comprises differential signals each having positive and negative components for mixing by said complimentary pairs.

6. The mixer of claim 1, further comprising a current-to-voltage converter for coveting the output signal to an output voltage.

7. The mixer of claim 6 wherein the current-to-voltage converter is a resister coupled with the mixer.

8. A mixer for mixing an input signal with a local oscillator signal to provide at an output signal, the mixer comprising:
an input and an output,
a voltage-to-current converter coupled with the input for converting an input signal into an input current signal,
a multiplier circuit coupled with the voltage-to-current converter for multiplying the current signal and a local oscillator signal to form an output signal at the output, and
a matching circuit coupling a component of the current signal to the input.

9. The mixer of claim 8 wherein the voltage-to-current converter comprises a first voltage drive transistor and the multiplier circuit comprises a second voltage transistor in series with the first voltage drive transistor for converting the oscillator signal to an oscillator current signal and mixing it with the input current signal.

10. The mixer of claim 8 wherein the matching circuit comprises a feedback resistor for feeding a part of the current signal back to the input.

11. The mixer of claim 8 further comprising a complimentary pair of each of said voltage-to-current converter, multiplier circuit and matching circuit, and wherein the input signal and a local oscillator comprises a differential signals having positive and negative components for mixing by said complimentary pairs.

12. The mixer of claim 11 wherein the multiplier circuit comprises a pair of parallel transistors driven by the local oscillator signal for steering the current signal through one or both of the transistors in synchronization with the local oscillator signal.

13. The mixer of claim 8 further comprising a current-to-voltage converter for coveting the output signal to an output voltage.

14. The mixer of claim 13 wherein the current-to-voltage converter is a resister coupled with the mixer.
